(19) United States
(12) Patent Application Publication
(10) Pub. No.: US 2026/0110393 A1
(43) Pub. Date: Apr. 23, 2026

(54) ROOFTOP COMPONENT SUPPORT DEVICES

(71) Applicant: Miro Industries, Inc., Heber City, UT (US)

(72) Inventors: Jason Reed Haddock, Heber City, UT (US); Samuel Richard Robins, Heber City, UT (US)

(21) Appl. No.: 19/363,459

(22) Filed: Oct. 20, 2025

Related U.S. Application Data
(60) Provisional application No. 63/709,002, filed on Oct. 18, 2024.

(51) Int. Cl. F16M 11/22; E04D 13/12; F16L 3/04

(52) U.S. Cl. CPC F16M 11/22; E04D 13/12; F16L 3/04

(57) ABSTRACT

A support member includes a body which extends along an axis between a first end and a second end and includes a base portion positioned opposite of a mounting portion. The device also includes an elongated channel, and the mounting portion including a mounting surface extending over a first side of the first elongated channel and a second side of the first elongated channel. A channel mouth opens through the mounting surface and has a reduced width relative to a width extending between the first and second sides of the first elongated channel.

### CROSS REFERENCE TO RELATED APPLICATIONS

The subject application claims the benefit of U.S. Provisional Patent Application No. 63/709,002 filed October 18, 2024, the contents of which are incorporated herein by reference in their entirety.

### FIELD

The present disclosure generally relates to component support devices. More particularly, but not exclusively, the present disclosure relates to support devices which may be used for the support of components on a rooftop or similar setting.

### BACKGROUND

Unless otherwise indicated herein, the materials described herein are not prior art to the claims in the present application and are not admitted to be prior art by inclusion in this section.

Various components, including HVAC ductwork, refrigeration lines, electric conduit and/or modular walkways, amongst others, may be positioned on the rooftop of a structure. Membrane materials may be used on the rooftop and these materials may be damaged by the components positioned on the rooftop. As such, direct positioning or fastening of these components to the membrane may typically be avoided. Support devices may be used to space the components from the rooftop and the components may be secured to the support devices. Generally speaking, a support device designed to prevent rooftop damage, facilitate easy securing of components thereto, and provide adjustability and ease of use may be desired.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, a support device includes a mounting surface positioned opposite of a base. At least one elongated channel is configured to facilitate coupling of one or more components with the support device. In one form for example, a portion of the mounting surface may be clamped by a component which is partially positioned in the elongated channel when the component is coupled to the support device. Additionally or alternatively, a component may be positioned on the mounting surface and coupled to the support device with one or more fasteners. The base may be configured relative to the mounting surface in a manner which provides stability to the support device, particularly when one or more components are coupled thereto. For example, the base may have greater overall surface area than the mounting surface and/or it may extend past the mounting surface in one or more directions.

In another embodiment, a support device includes a body extending along an axis between a first end and a second end and including a base portion positioned opposite of a mounting portion. The body includes a trapezoidal cross-sectional configuration. The support device also includes a first elongated channel. The mounting portion includes a mounting surface extending partially over a first side of the first elongated channel and an opposite, second side of the first elongated channel to define a first channel mouth having a reduced width relative to a width extending between the first side of the first elongated channel and the second side of the first elongated channel.

In yet another embodiment, a support device includes a base extending in a first direction between a first end and an opposite, second end, and in a second direction across a first distance between a first base side and an opposite, second base side. The device also includes a mounting surface spaced from the base portion and extending in the second direction across a second distance between a first side of the mounting surface and a second side of the mounting surface where the second distance is less than the first distance. The device also includes a first elongated channel including a first channel mouth opening through the mounting surface. The first channel mouth has a reduced width relative to a width extending across the elongated channel at a location between the mounting surface and the base.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a component support device;

FIG. 2 is an alternative, perspective view of the component support device of FIG. 1;

FIG. 3 is an end view of the component support device of FIG. 1;

FIGS. 4A-C are perspective views of the component support device of FIG. 1 engaged with various component mounting elements;

FIG. 5 is a perspective view of the component support device of FIG. 1 engaged with modular walkway components;

FIG. 6 is a perspective view of an alternative embodiment component support device engaged with component coupling members;

FIG. 7 is a perspective view of another alternative embodiment component support device.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to component support devices. More particularly, but not exclusively, the present disclosure relates to support devices which may be used for the support of components on a rooftop or similar setting. It will be appreciated that embodiments disclosed herein may be employed in a variety of fields and/or operating environments where the functionality disclosed herein may be useful. Accordingly, the scope of the invention should not be construed to be limited to the exemplary implementations and operating environments disclosed herein.

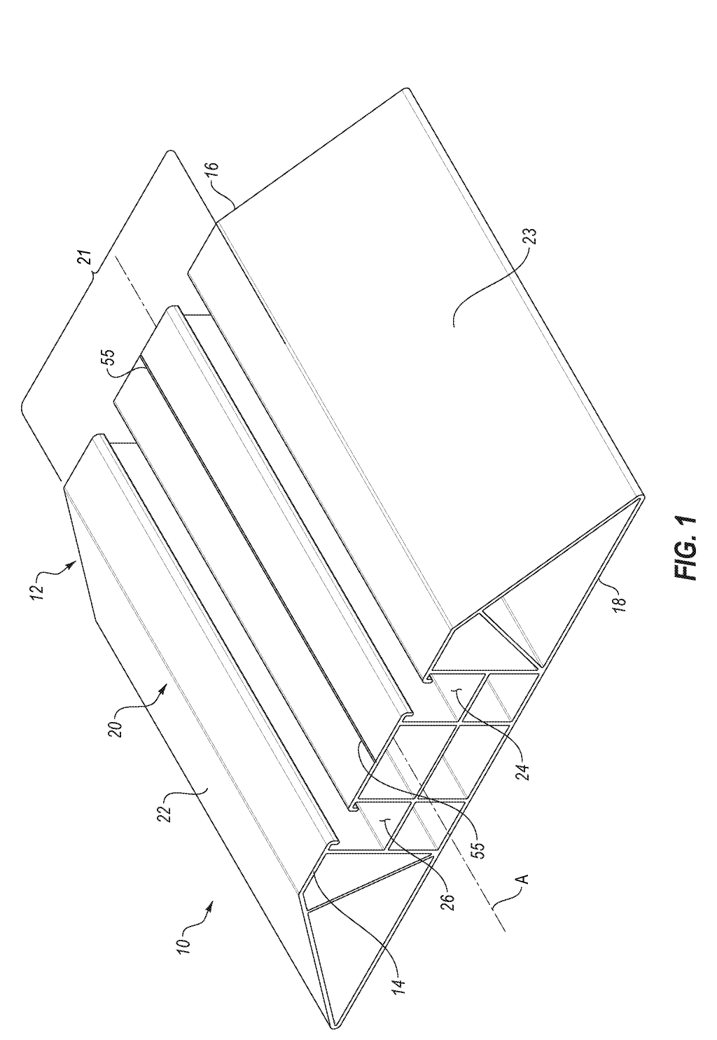

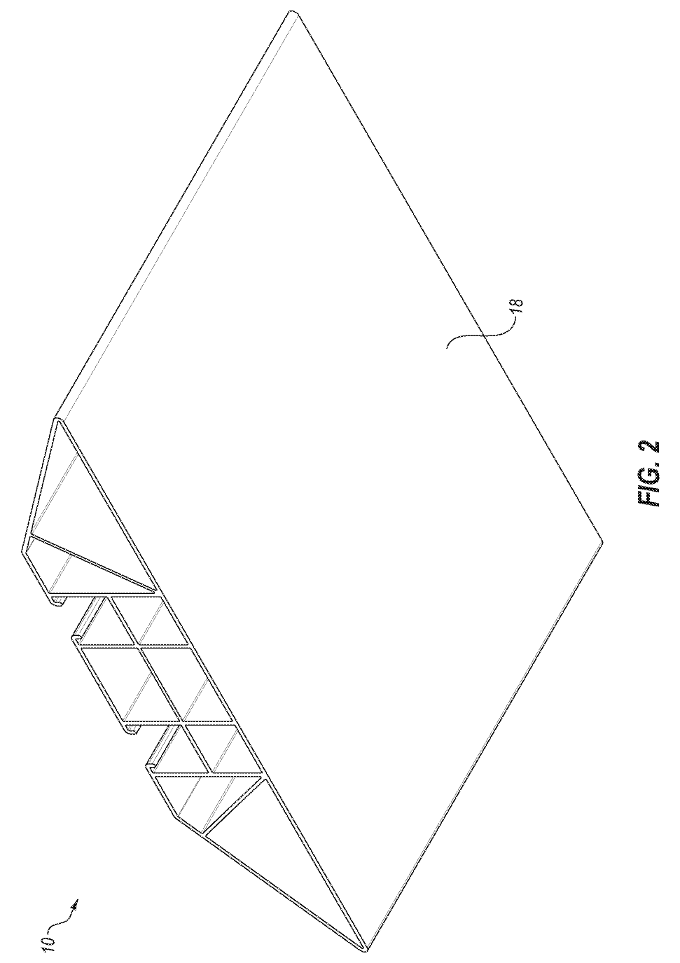

With general reference to FIGS. 1-3 for example, there is illustrated an example embodiment of a component support device 10. The component support device 10 includes a body 12 which extends along an axis A between a first end 14 and a second end 16. The body 12 includes a base portion 18 positioned opposite of a mounting portion 20 including a mounting surface 21. A first side portion 22 extends obliquely to and between the base portion 18 and the mounting portion 20, and a second side portion 23 extends obliquely to and between the base portion 18 and the mounting portion 20.

When viewed from its end, or in section relative to the axis A, the body 12 generally includes a trapezoidal cross-sectional configuration, although other variations in this configuration are possible and contemplated. In the illustrated form, the surface area of the base portion 18 is greater than that of the mounting portion 20. The surface area of the base portion 18 may be designed or selected to increase the contact area between the component support device 10 and a surface on which it is positioned, such as a rooftop membrane material, in order to minimize impact or damage to the surface by the component support device 10.

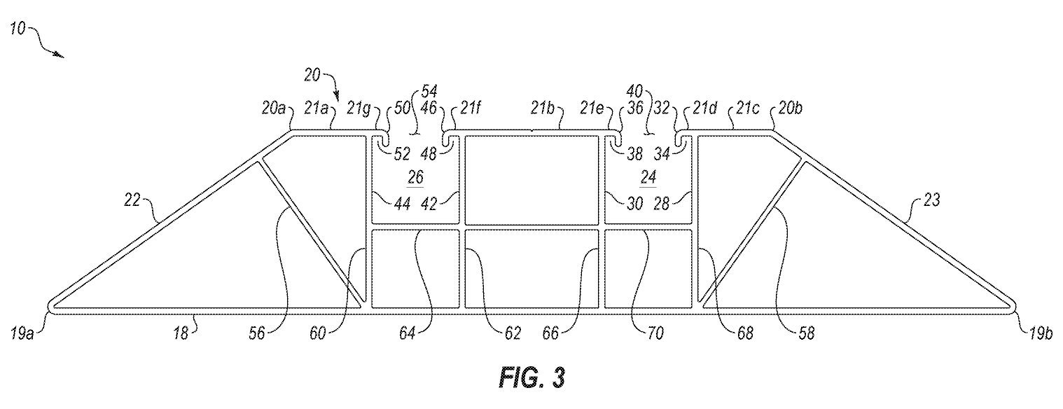

Additionally or alternatively, the base portion 18 may be configured relative to the mounting portion 20 in a manner that provides stability to the component support device 10, including when one or more components are coupled thereto. As illustrated in FIG. 3 for example, the base portion 18 extends between a first base side 19a and a second base side 19b, and the mounting portion 20 extends between a first side 20a and a second side 20b. The distance between the first base side 19a and the second base side 19b is greater than the distance between the first side 20a of the mounting portion 20 and the second side 20b of the mounting portion 20. Further, in the illustrated form, the mounting portion 20 is positioned between the first base side 19a and the second base side 19b, although other variations are possible.

The component support device 10 also includes a first elongated channel 24 positioned along the mounting portion 20 and a second elongated channel 26 positioned along the mounting portion 20, although variations in the number of elongated channels present are possible and contemplated. A first portion 21a of the mounting surface 21 is positioned on one side of the first elongated channel 24, a second portion 21b of the mounting surface 21 is positioned between the first elongated channel 24 and the second elongated channel 26, and a third portion 21c of the mounting surface 21 is positioned on the other side of the second elongated channel 26. In this configuration, the first elongated channel 24 is laterally spaced from the second elongated channel 26 by the second portion 21b of the mounting surface 21.

As best illustrated in FIG. 3 for example, a portion 21d of the mounting surface 21 extends partially over a first side 28 of the first elongated channel 24 and a portion 21e of the mounting surface 21 extends partially over a second side 30 of the first elongated channel 24. In this arrangement, the portion 21d of the mounting surface 21 and the portion 21e of the mounting surface 21 may provide a blocking arrangement which prevents removal of an item from the first elongated channel 24. The portion 21d includes a convexly curved return 32 which partially extends into the first elongated channel 24 and a first slot 34 is defined in the first elongated channel 24 between the return 32 and the first side 28 of the first elongated channel 24. The portion 21e includes a convexly curved return 36 which partially extends into the first elongated channel 24 and a second slot 38 is defined in the first elongated channel 24 between the return 36 and the second side 30 of the first elongated channel 24. In this arrangement, a channel mouth 40 is positioned between the portion 21d of the mounting surface 21 and the portion 21e of the mounting surface 21, and the channel mouth 40 has a reduced width relative to a width extending between the first side 28 and the second side 30 of the first elongated channel 24.

The first slot 34 and the second slot 38 may be configured to receive a portion of a coupling member such as a clamp which may be used to couple a component to the component support device 10, although forms in which no portion of the coupling member is positioned in the first slot 34 or the second slot 38 are possible and contemplated. By way of non-limiting example, the component may be HVAC ductwork, refrigeration lines, electric conduit, plumbing lines and/or modular walkways. The coupling member may be slid along the first elongated channel 24 until a desired position is achieved, and different portions of the coupling member may be secured with one another to provide an arrangement which clamps a portion of the component support device 10 (e.g., the mounting surface 21) therebetween and fixes the positioning of the coupling member relative to the component support device 10.

With reference again to FIG. 3, a portion 21f of the mounting surface 21 extends partially over a first side 42 of the second elongated channel 26 and a portion 21g of the mounting surface 21 extends partially over a second side 44 of the second elongated channel 26. In this arrangement, the portion 21f of the mounting surface 21 and the portion 21g of the mounting surface may provide a blocking arrangement which prevents removal of an item from the second elongated channel 26. The portion 21f of the mounting surface 21 includes a convexly curved return 46 which partially extends into the second elongated channel 26 and a first slot 48 is defined in the second elongated channel 26 between the return 46 and the first side 42 of the second elongated channel 26. The portion 21g of the mounting surface 21 includes a convexly curved return 50 which partially extends into the second elongated channel 26 and a second slot 52 is defined in the second elongated channel 26 between the return 50 and the second side 44 of the second elongated channel 26. In this arrangement, a channel mouth 54 is positioned between the portion 21f of the mounting surface 21 and the portion 21g of the mounting surface 21, and the channel mouth 54 has a reduced width relative to a width extending between the first side 42 and the second side 44 of the second elongated channel 26.

The first slot 48 and the second slot 52 may be configured to receive a portion of a coupling member such as a clamp which may be used to couple a component to the component support device 10, although forms in which no portion of the coupling member is positioned in the first slot 48 or the second slot 52 are possible and contemplated. By way of non-limiting example, the component may be HVAC ductwork, refrigeration lines, electric conduit, plumbing lines and/or modular walkways. The coupling member may be slid along the second elongated channel 26 until a desired position is achieved, and different portions of the coupling member may be secured with one another to provide an arrangement which clamps a portion of the component support device 10 (e.g., the mounting surface 21) therebetween and fixes the positioning of the coupling member relative to the component support device 10. Other variations for the engagement between the component support device 10 and different coupling members or other devices are also possible and contemplated.

While not previously discussed, it should be appreciated that one or more components may also be positioned on the mounting surface 21 and coupled to the component support device 10 with one or more fasteners. With reference to FIG. 1 for example, the mounting surface 21 includes a groove 55 defined in the second portion 21b thereof. Amongst other things, the groove 55 may support alignment of an end of one or more fasteners along the second portion 21b when the fasteners are used to couple a component to the component support device 10. In the illustrated form, the groove 55 is centered in the second portion 21b of the mounting surface 21, although other variations are possible. However, when positioned as illustrated, the groove 55 promotes engagement of the fasteners at or near the center of the second portion 21b of the mounting surface 21.

The component support device 10 also includes a number of support elements which extend between the base portion 18 and the mounting portion 20, or between the base portion 18 and the first side portion 22 or the second side portion 23. The support elements may provide structural support or rigidity to the component support device 10. With further reference to FIG. 3 for example, a first support element 56 extends obliquely from the base portion 18 to the first side portion 22, and a second support element 58 extends obliquely from the base portion 18 to the second side portion 23. In addition, a third support element 60 extends from the base portion 18 to the mounting portion 20, and a fourth support element 62 extends from the base portion 18 to the mounting portion 20, with the third and fourth support elements 60, 62 defining the opposing sides of the second elongated channel 26. Generally speaking, the first support element 56 and the third support element 60 extend from a common location of the base portion 18. A first transverse member 64 extends between the third support element 60 and the fourth support element 62 and provides a surface of the second elongated channel 26 opposite of the second channel mouth 54.

A fifth support element 66 extends from the base portion 18 to the mounting portion 20 and a sixth support element 68 extends from the base portion 18 to the mounting portion 20, with the fifth and sixth support elements 66, 68 defining the opposing sides of the first elongated channel 24. Generally speaking, the second support element 58 and the sixth support element 68 extend from a common location of the base portion 18. A second transverse member 70 extends between the fifth support element 66 and the sixth support element 68 and provides a surface of the first elongated channel 24 opposite of the first channel mouth 40.

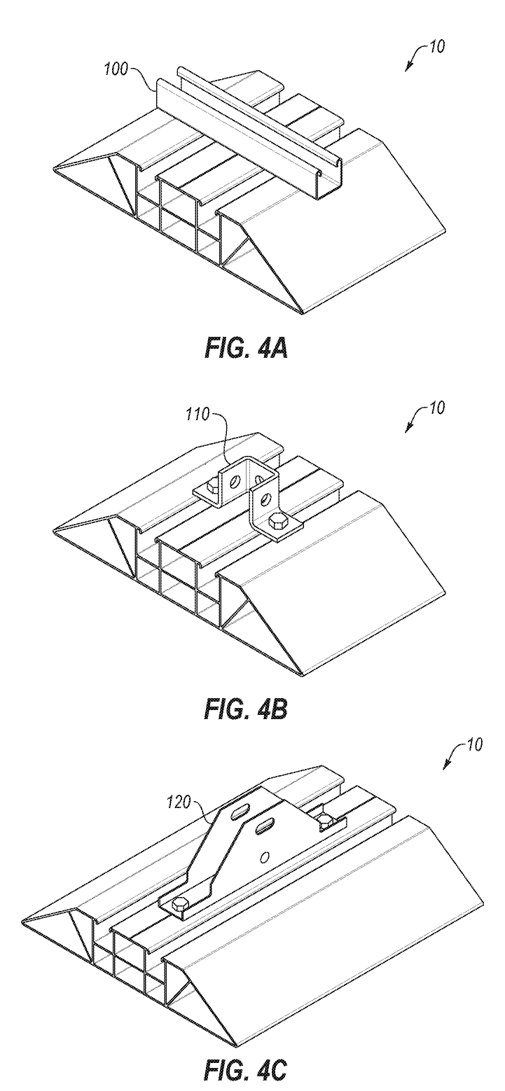

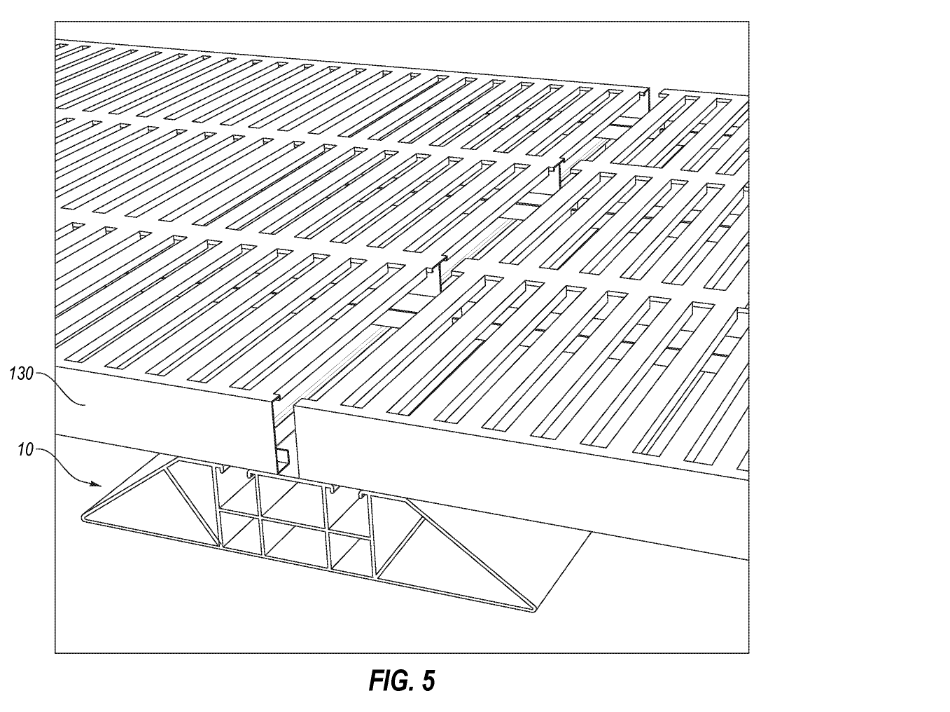

As suggested above, the component support device 10 may be engaged or coupled with a number of different coupling members configured to provide engagement or coupling between a component and the component support device 10. A few non-limiting examples of different coupling members engaged with the component support device 10 and/or uses of the component support device 10 are illustrated in FIGS. 4A-4C and 5. In FIG. 4A for example, a channel strut 100 is engaged with the component support device 10, and the strut 100 may be configured to engage with a number of other devices configured to receive, couple or engage with various other components. In the arrangement of FIG. 4A, one or more devices may be positioned in the first and second elongated channels 24, 26 in order to facilitate coupling of the strut 100 with the component support device 10. Additionally or alternatively, one or more fasteners may extend through the strut 100 and engage with the mounting surface 21 at locations between or lateral to the first and second elongated channels 24, 26.

In FIG. 4B, a coupling member 110 is engaged with the component support device 10 by a threaded interconnection between externally threaded bolts which extend into and engage with internally threaded members positioned in the first and second elongated channels 24, 26. In FIG. 4C, a coupling member 120 is engaged with the component support device 10 by threaded fasteners which engage with the second portion 21b of the mounting surface 21 positioned between the first elongated channel 24 and the second elongated channel 26. In this form, the fasteners are generally aligned with the groove 55 formed in the mounting surface 21.

In FIG. 5, a number of modular walkway members 130 are illustrated in engagement with the component support device 10. In this arrangement, a plurality of component support devices 10 may be used and spaced apart from one another in order to create a modular walkway positioned above the surface on which the component support devices 10 are positioned in order to prevent damage to the surface. The walkway members may be coupled to the component support devices 10 with one or more fasteners engaged with the mounting surface 21 and/or one or more of the elongated channels 24 and 26.

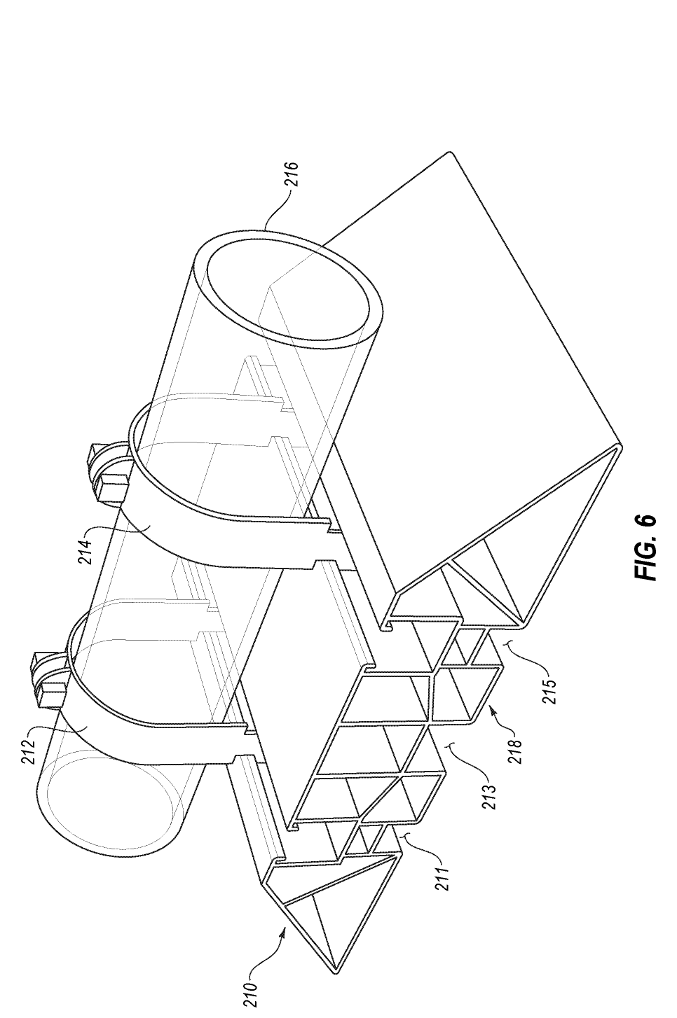

Referring now to FIG. 6, there is illustrated an alternative embodiment component support device 210. Generally speaking, the component support device 210 is substantially similar to the component support device 10 except that the component support device 210 includes a number of elongated channels 211, 213 and 215 along its base portion 218 such that the surface of the base portion 218 is discontinuous, and the support elements thereof between the base portion 218 and the mounting portion 220 have a slightly different configuration. The component support device 210 may function and/or be used as described herein in connection with the component support device 10. In FIG. 6, a pair of clamp members 212 and 214 are engaged with the component support member 210 and configured to receive a pipe or conduit 216 and provide a coupling arrangement between the pipe or conduit 216 and the component support device 210.

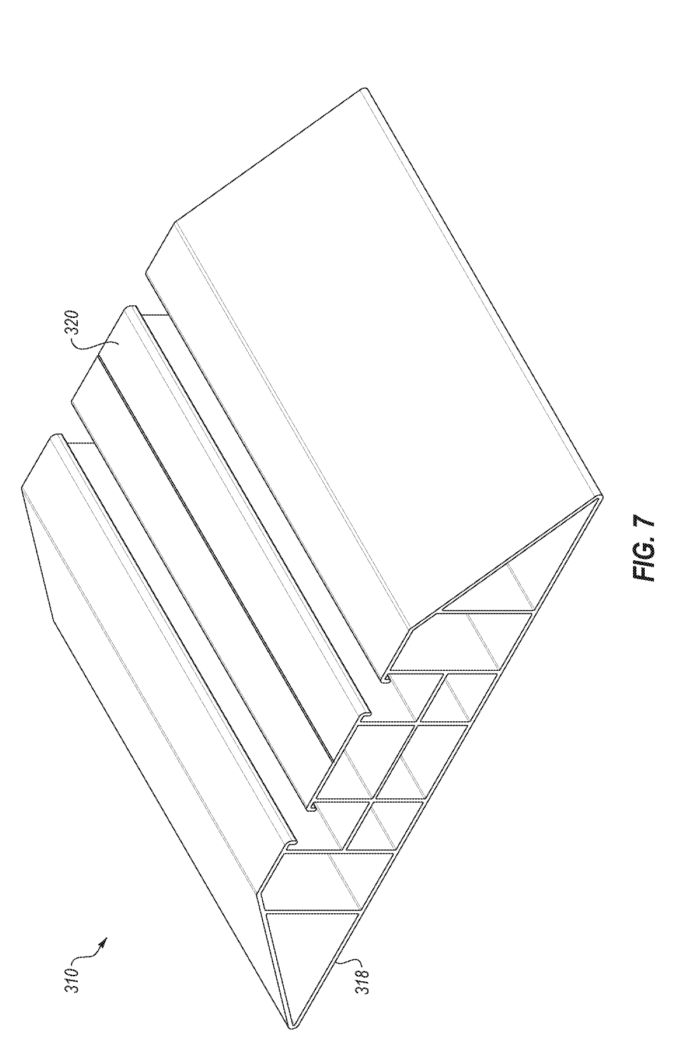

Turning now to FIG. 7, there is illustrated another alternative embodiment component support device 310. Generally speaking, the component support device 310 is substantially similar to the component support device 10 except that in the component support device 310 the support elements thereof generally extend orthogonally to the base portion 318 and the mounting portion 320.

The component support members described herein may be made from a variety of different materials. In some aspects, the component support members may be made from a polymer or plastic material and formed via an extrusion process. However, other variations are possible and contemplated In one embodiment, a support device includes a body extending along an axis between a first end and a second end and including a base portion positioned opposite of a mounting portion. The body includes a trapezoidal cross-sectional configuration. The body further includes a first elongated channel, and the mounting portion includes a mounting surface extending partially over a first side of the first elongated channel and an opposite, second side of the first elongated channel to define a first channel mouth having a reduced width relative to a width extending between the first side of the first elongated channel and the second side of the first elongated channel.

In one form, the support device further includes a number of support elements extending between the base portion and the mounting portion.

In another form, the support device further includes a first side portion extending obliquely to and between the mounting portion and the base portion, and a second side portion extending obliquely to and between the mounting portion and the base portion.

In one aspect of this form, the support device further includes a first support element extending obliquely to and from the base portion to the first side portion and a second support element extending obliquely to and from the base portion to the second side portion.

In a further aspect of this form, the support device further includes a third support element extending from the base portion to the mounting portion and a fourth support element extending from the base portion to the mounting portion. The third support element is laterally spaced from the fourth support element and the third support element and the fourth support element define the first side and the second side of the first elongated channel.

In yet another aspect, the support member further includes a transverse member extending between the third support element and the fourth support element and providing a surface of the first elongated channel opposite of the first channel mouth.

In still another aspect, the first support element and the third support element extend from a common location of the base portion.

In another form, the support member further includes a second elongated channel, and the mounting portion extends partially over opposite sides of the second elongated channel to define a second channel mouth having a reduced width relative to a width extending between the opposite sides of the second elongated channel.

In one aspect of this form, the first elongated channel is laterally spaced from the second elongated channel.

In still another aspect, the mounting surface includes a first return extending into the first elongated channel and a second, oppositely positioned return extending into the first elongated channel.

In a further aspect, the support member further a first slot positioned between the first return and the first side of the first elongated channel and a second slot positioned between a second return and the second side of the first side elongated channel.

In yet another form, the base portion has a greater surface area than the mounting portion.

In another embodiment, a method includes providing a support device as described herein; positioning a clamp member in a first elongated channel of the support device; and engaging a fastener member with the clamp member to fix the position of the clamp member in the first elongated channel.

In yet another embodiment, a support device includes a base extending in a first direction between a first end and an opposite, second end, and in a second direction across a first distance between a first base side and an opposite, second base side. The device further includes a mounting surface spaced from the base portion and extending in the second direction across a second distance between a first side of the mounting surface and a second side of the mounting surface where the second distance is less than the first distance. The device also includes a first elongated channel including a first channel mouth opening through the mounting surface. The first channel mouth has a reduced width relative to a width extending across the elongated channel at a location between the mounting surface and the base.

In one form, the reduced width of the first channel mouth is defined by the mounting surface extending over opposite sides of the first elongated channel.

In another form, the first elongated channel includes a first slot positioned between a first side thereof and a first portion of the mounting surface extending into the first elongated channel and a second slot positioned between a second side thereof and a second portion of the mounting surface extending into the first elongated channel.

In still another form, the device further includes an inclined surface extending between the mounting surface and the base.

In another form, the device further includes a second elongated channel positioned between the first elongated channel and one of the first side of the mounting surface and the second side of the mounting surface.

In yet another form, the device further includes a plurality of support members extending between the base and the mounting surface.

In another form, a total surface area of the base is greater than a total surface area of the mounting surface.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A support device, comprising:
a body extending along an axis between a first end and a second end and including a base portion positioned opposite of a mounting portion, wherein the body includes a trapezoidal cross-sectional configuration; and
a first elongated channel, wherein the mounting portion includes a mounting surface extending partially over a first side of the first elongated channel and an opposite, second side of the first elongated channel to define a first channel mouth having a reduced width relative to a width extending between the first side of the first elongated channel and the second side of the first elongated channel.

2. The support device of claim 1, further comprising a number of support elements extending between the base portion and the mounting portion.

3. The support device of claim 1, further comprising a first side portion extending obliquely to and between the mounting portion and the base portion, and a second side portion extending obliquely to and between the mounting portion and the base portion.

4. The support device of claim 3, further comprising a first support element extending obliquely to and from the base portion to the first side portion, and a second support element extending obliquely to and from the base portion to the second side portion.

5. The support device of claim 4, further comprising a third support element extending from the base portion to the mounting portion, and a fourth support element extending from the base portion to the mounting portion, wherein the third support element is laterally spaced from the fourth support element, and the third support element and the fourth support element define the first side and the second side of the first elongated channel.

6. The support device of claim 5, further comprising a transverse member extending between the third support element and the fourth support element and providing a surface of the first elongated channel opposite of the first channel mouth.

7. The support device of claim 5, wherein the first support element and the third support element extend from a common location of the base portion.

8. The support device of claim 1, further comprising a second elongated channel, wherein the mounting surface extends partially over opposite sides of the second elongated channel to define a second channel mouth having a reduced width relative to a width extending between the opposite sides of the second elongated channel.

9. The support device of claim 8, wherein the first elongated channel is laterally spaced from the second elongated channel.

10. The support device of claim 1, wherein the mounting surface includes a first return extending into the first elongated channel and a second, oppositely positioned return extending into the first elongated channel.

11. The support device of claim 10, further comprising a first slot positioned between the firs return and the first side of the first elongated channel and a slot positioned between the second return and the second side of the first elongated channel.

12. The support device of claim 1, wherein the base portion has a greater surface area than the mounting portion.

13. A method, comprising:
providing a support member according to claim 1;
positioning a clamp member in the first elongated channel; and
engaging a fastener member with the clamp member to fix the position of the clamp member in the first elongated channel.

14. A support device, comprising:
a base extending in a first direction between a first end and an opposite, second end, and in a second direction across a first distance between a first base side and an opposite, second base side;
a mounting surface spaced from the base and extending in the second direction across a second distance between a first side of the mounting surface and a second side of the mounting surface, the second distance being less than the first distance;
a first elongated channel including a first channel mouth opening through the mounting surface, wherein the first channel mouth has a reduced width relative to a width extending across the first elongated channel at a location between the mounting surface and the base.

15. The support device of claim 14, wherein the reduced width of the first channel mouth is defined by the mounting surface extending over opposite sides of the first elongated channel.

16. The support device of claim 14, wherein the first elongated channel includes a first slot positioned between a first side thereof and a first portion of the mounting surface extending into the first elongated channel and a second slot positioned between a second side thereof and a second portion of the mounting surface extending into the first elongated channel.

17. The support device of claim 14, further comprising an inclined surface extending between the mounting surface and the base.

18. The support device of claim 14, further comprising a second elongated channel positioned between the first elongated channel and one of the first side of the mounting surface and the second side of the mounting surface.

19. The support device of claim 14, further comprising a plurality of support members extending between the base and the mounting surface.

20. The support device of claim 14, wherein a total surface area of the base is greater than a total surface area of the mounting surface.
